(19) United States
(12) Patent Application Publication
(10) Pub. No.: US 2026/0237221 A1
(43) Pub. Date: Aug. 13, 2026

(54) MOVING-BODY DETECTION DEVICE, SYSTEM, METHOD, AND NON-TRANSITORY COMPUTER READABLE MEDIUM STORING PROGRAM

(71) Applicant: NEC Corporation, Tokyo (JP)

(72) Inventors: Hisahiro OBA, Tokyo (JP); Kosuke TONO, Tokyo (JP); Masahito SAKAI, Tokyo (JP); Daisuke MORI, Tokyo (JP)

(73) Assignee: NEC Corporation, Tokyo (JP)

(21) Appl. No.: 19/156,025

(22) PCT Filed: Feb. 21, 2023
(86) PCT No.: PCT/JP2023/006199

§ 371 Date: Aug. 13, 2025

(51) Int. Cl. G06V 20/58; G06V 10/60; G06V 10/75

(52) U.S. Cl. CPC G06V 20/58; G06V 10/60; G06V 10/751

(57) ABSTRACT

The purpose of the present disclosure is to provide a moving body detection device capable of accurately detecting a moving body. A moving body detection device (100) comprises an acquisition unit (110) that acquires a captured video, a first setting unit (120) that sets moving body detection conditions on the basis of related information containing information related to the video, and a detection unit (130) that detects a moving body from frames constituting the video on the basis of the moving body detection conditions. The moving body detection device (100) adjusts the moving body detection conditions on the basis of the related information, and thus can accurately detect a moving body.

### TECHNICAL FIELD

The present disclosure relates to a moving-body detection device, system, method, and a non-transitory computer readable medium storing a program.

### BACKGROUND ART

In a case where a moving body such as a person is included in a video imaged by an in-vehicle camera or the like during traveling of a vehicle, there is a case where it is necessary to blur the moving body, from the viewpoint of personal information protection. In order to blur the moving body included in the video, it is required to accurately detect the moving body from the imaged video.

PTL 1 discloses a technique for detecting a pedestrian from a video while switching a pedestrian recognition level according to a speed of a vehicle.

### CITATION LIST

### Patent Literature

PTL 1: JP 2009-064274 A

### SUMMARY OF INVENTION

### Technical Problem

If erroneous detection occurs in a case where a moving body is detected from a video, there is a possibility that blurring occurs in a region where there is no moving body in the video, that is, blurring is not needed. Therefore, it is required to improve detection accuracy of the moving body included in the video.

The present disclosure has been made to solve such a problem, and an object of the present disclosure is to provide a moving-body detection device, system, method, and a non-transitory computer readable medium that stores a program that can accurately detect a moving body.

### Solution to Problem

A moving-body detection device according to the present disclosure includes
an acquisition unit for acquiring an imaged video,
a first setting unit for setting a moving body detection condition based on related information including information related to the video, and
a detection unit for detecting a moving body from a frame included in the video based on the moving body detection condition.

A moving-body detection system according to the present disclosure includes
an imaging apparatus that images a video of surroundings and
a moving-body detection device communicable with the imaging apparatus, in which
the moving-body detection device includes
an acquisition unit that acquires a video imaged by the imaging apparatus,
a first setting unit that sets a moving body detection condition based on related information including information related to the video, and
a detection unit that detects a moving body from a frame included in the video based on the moving body detection condition.

A moving-body detection method according to the present disclosure performed by a computer, includes
a process for acquiring an imaged video,
a process for setting a moving body detection condition based on related information including information related to the video, and
a process for detecting a moving body from a frame included in the video based on the moving body detection condition.

A non-transitory computer readable medium according to the present disclosure stores a moving-body detection program for causing a computer to execute processing including
processing for acquiring an imaged video,
processing for setting a moving body detection condition based on related information including information related to the video, and
processing for detecting a moving body from a frame included in the video based on the moving body detection condition.

### Advantageous Effects of Invention

According to the present disclosure, it is possible to provide a moving-body detection device, system, method, and a non-transitory computer readable medium storing a program that can accurately detect a moving body.

### BRIEF DESCRIPTION OF DRAWINGS

FIG. 1 is a block diagram illustrating a configuration of a moving-body detection device according to a first example embodiment.

FIG. 2 is a flowchart illustrating a flow of a moving-body detection method according to the first example embodiment.

FIG. 3 is a block diagram illustrating a configuration of a moving-body detection system according to a second example embodiment.

FIG. 4 is a block diagram illustrating a configuration of a moving-body detection device according to the second example embodiment.

FIG. 5 is a diagram illustrating an example of a frame in which a moving body is detected.

FIG. 6 is a flowchart illustrating a flow of a moving-body detection method according to the second example embodiment.

FIG. 7 is a block diagram illustrating a configuration of a moving-body detection device according to a third example embodiment.

FIG. 8 is a flowchart illustrating a flow of second threshold setting processing according to the third example embodiment.

FIG. 9 is a flowchart illustrating a flow of a moving-body detection method according to the third example embodiment.

FIG. 10 is a block diagram illustrating a configuration of a moving-body detection system according to a fourth example embodiment.

FIG. 11 is a flowchart illustrating a flow of second threshold setting processing according to the fourth example embodiment.

FIG. 12 is a flowchart illustrating a flow of a moving-body detection method according to the fourth example embodiment.

FIG. 13 is a block diagram illustrating a configuration of a moving-body detection device according to a fifth example embodiment.

FIG. 14 is a flowchart illustrating a flow of third threshold setting processing according to the fifth example embodiment.

FIG. 15 is a flowchart illustrating a flow of a moving-body detection method according to the fifth example embodiment.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description.

### First Example Embodiment

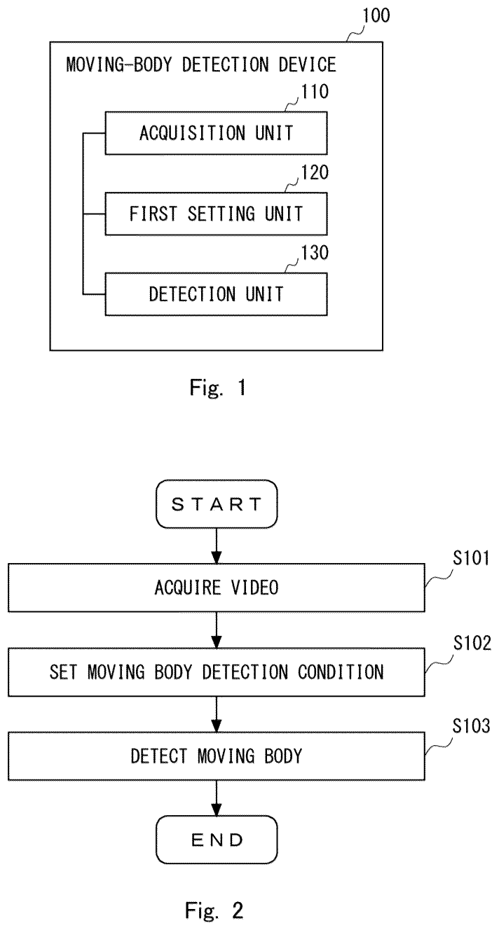

FIG. 1 is a block diagram illustrating a configuration of a moving-body detection device 100 according to a first example embodiment. The moving-body detection device 100 includes an acquisition unit 110, a first setting unit 120, and a detection unit 130. The moving-body detection device 100 is connected to a network 500 (not illustrated), and the network 500 may be a wired or wireless network. An imaging apparatus 300 or the like (not illustrated) is connected to the network 500. The imaging apparatus 300 is an apparatus that is provided in a vehicle 310 (not illustrated) and images surroundings of the vehicle. A video imaged by the imaging apparatus 300 is a normal moving image and includes a plurality of frames.

The acquisition unit 110 acquires the video imaged by the imaging apparatus 300 provided in the vehicle 310. It is assumed that the video include at least one frame and usually include a plurality of frames. The first setting unit 120 sets a moving body detection condition based on related information. The related information is information related to a video and is, for example, a dispersion and a luminance of a frame included in the video, a time during the video is imaged, or the like. The detection unit 130 detects a moving body from the frame included in the video acquired by the acquisition unit 110, based on the moving body detection condition set by the first setting unit 120. The moving body moves on a road and is, for example, a person, an automobile, a motorcycle, an electric scooter, or the like.

In a case where the moving body such as a person is clearly imaged in the frame included in the video, it is preferable to detect the moving body and blur the moving body, for privacy protection. On the other hand, if an unclear moving body is blurred, the number of blurred regions in the video becomes larger than necessary, and accordingly, visibility of the video is lowered, and this is not preferable. Therefore, in a case where the moving body imaged in the frame is unclear, necessary to blur the moving body is low.

Clarity of the frame included in the video changes according to an imaging environment or the like. For example, a frame with a large dispersion, that is, a clearly imaged frame is more clear than a frame with a small dispersion. In the clear frame, there is a high possibility that the moving body is clearly imaged. Therefore, in a case where the frame is clear, the first setting unit 120 sets the moving body detection condition in such a way that the moving body is more easily detected than a case where the frame is unclear.

FIG. 2 is a flowchart illustrating a flow of a moving-body detection method according to the first example embodiment. First, the acquisition unit 110 acquires an imaged video (step S101). Next, the first setting unit 120 set the moving body detection condition based on the related information including information related to the video acquired in step S101 (step S102). Next, the detection unit 130 detects a moving body from a frame included in the video acquired in step S101 based on the moving body detection condition set in step S102 (step S103). In this way, since the moving-body detection method according to the first example embodiment adjusts the moving body detection condition according to the clarity of the frame, the moving body can be accurately detected.

The moving-body detection device 100 includes a processor, a memory, and a storage apparatus as components not illustrated. In addition, the storage apparatus stores a computer program in which processing of the moving-body detection method according to the first example embodiment is implemented. Then, the processor reads the computer program from the storage apparatus into the memory and executes the computer program. As a result, the processor achieves functions as the acquisition unit 110, the first setting unit 120, and the detection unit 130.

Alternatively, each of the acquisition unit 110, the first setting unit 120, and the detection unit 130 may be achieved by dedicated hardware. Some or all of the components of each apparatus may be achieved by a general-purpose or dedicated circuitry, a processor, or a combination thereof. These components may be configured with a single chip or may be configured with a plurality of chips connected via a bus. Some or all of the components of each apparatus may be achieved by a combination of the above-described circuitry or the like and a program. A central processing unit (CPU), a graphics processing unit (GPU), a field-programmable gate array (FPGA), or the like can be used as the processor.

In a case where some or all of the components of the moving-body detection device 100 are achieved by a plurality of information processing apparatuses, circuits, and the like, the plurality of information processing apparatuses, circuits, and the like may be disposed in a centralized manner or in a distributed manner. For example, the information processing apparatuses, the circuits, or the like may be achieved in the form of a client server system, a cloud computing system, or the like in which they are connected to each other through a communication network. A function of the moving-body detection device 100 may be provided in a Software as a Service (SaaS) format.

### Second Example Embodiment

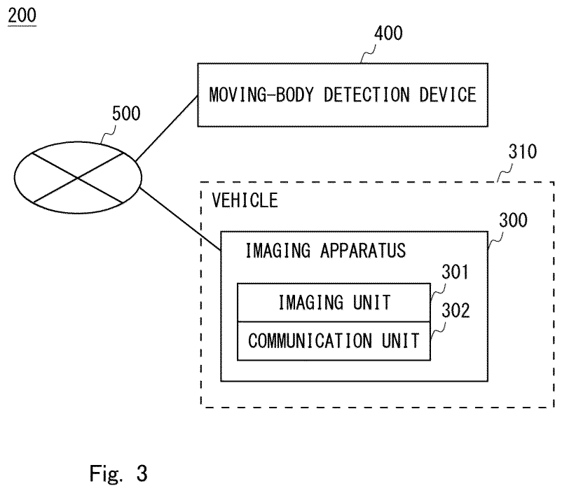

A second example embodiment is a specific example of the first example embodiment described above. In the second example embodiment, a moving body detection condition is set with a frame dispersion as related information. FIG. 3 is a block diagram illustrating a configuration of a moving-body detection system 200 according to the second example embodiment. The moving-body detection system 200 includes an imaging apparatus 300 and a moving-body detection device 400. The imaging apparatus 300 is connected to the moving-body detection device 400 via a network 500. Description overlapping with the first example embodiment will be omitted as appropriate.

The moving-body detection system 200 is a system that detects a moving body from a video imaged in a vehicle 310. The vehicle 310 is, for example, an automobile and may be a vehicle other than an automobile such as a motorcycle or a bicycle. The imaging apparatus 300 is provided in the vehicle 310. The imaging apparatus 300 is an apparatus that images a scene around the vehicle 310 and is, for example, a drive recorder. The imaging apparatus 300 includes an imaging unit 301 and a communication unit 302. The imaging unit 301 is a camera. The imaging unit 301 images, for example, a scene in front of the vehicle 310, that is, a scene that a driver sitting on a driver's seat of the vehicle 310 can see. The communication unit 302 is a communication interface with the network 500. The communication unit 302 transmits the video imaged by the imaging unit 301 to the moving-body detection device 400 via the network 500.

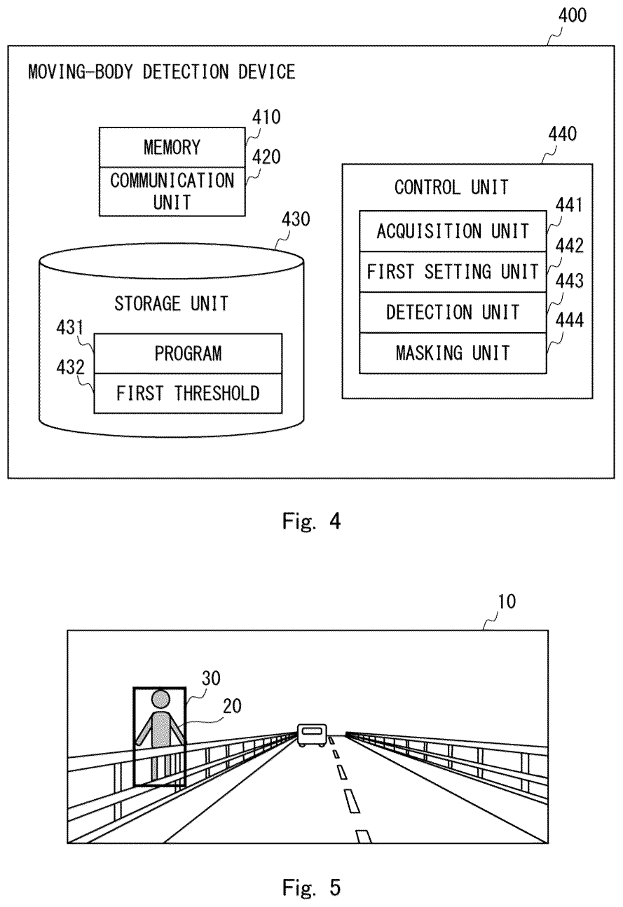

Next, a configuration of the moving-body detection device 400 will be described in detail, with reference to FIG. 4. FIG. 4 is a block diagram illustrating the configuration of the moving-body detection device 400. The moving-body detection device 400 includes a memory 410, a communication unit 420, a storage unit 430, and a control unit 440.

The memory 410 is a storage region for temporarily storing processing contents of the control unit 440, and is, for example, a volatile storage device such as a random access memory (RAM). The communication unit 420 is an interface that communicates with outside of the moving-body detection device 400. The storage unit 430 is a storage apparatus that stores a program 431, a first threshold 432, or the like. The first threshold 432 is a numerical value used in a case where a moving body is detected. The program 431 is a computer program in which moving body detection processing according to the second example embodiment is implemented.

The control unit 440 includes an acquisition unit 441, a first setting unit 442, a detection unit 443, and a masking unit 444. The control unit 440 is a control apparatus that controls an operation of the moving-body detection device 400 and is, for example, a processor such as a CPU. The control unit 440 reads the program 431 from the storage unit 430 into the memory 410 and executes the program. As a result, the control unit 440 achieves functions as the acquisition unit 441, the first setting unit 442, the detection unit 443, and the masking unit 444.

The acquisition unit 441 acquires the video transmitted from the imaging apparatus 300. The video normally includes a plurality of frames. It is assumed that the video may include identification information or the like. The identification information is information for identifying the vehicle 310 in which the imaging apparatus 300 that images the video is provided.

The first setting unit 442 sets the moving body detection condition based on the related information. Specifically, first, the first setting unit 442 calculates a dispersion of each frame included in the video acquired by the acquisition unit 441. The dispersion of the frame is a numerical value calculated by subtracting a square of an average from an average of squares of all pixel values in the frame, and indicates a variation in the number of pixels in the frame. Next, the first setting unit 442 sets the first threshold 432 based on the dispersion of the frame and stores the first threshold 432 in the storage unit 430. The first threshold 432 is a threshold used in a case where a moving body is detected. In a case where the dispersion of the frame is small, that is the frame is blurred, the first setting unit 442 sets the first threshold 432 to be higher than that in a case where the dispersion of the frame is large. In a case where the dispersion of the frame is large, the first setting unit 442 sets the first threshold 432 to be lower than that in a case where the dispersion of the frame is small.

The detection unit 443 detects a moving body from the video acquired by the acquisition unit 441. Specifically, the detection unit 443 calculates a moving body detection score, for each frame included in the video acquired by the acquisition unit 441. The moving body detection score is a numerical value calculated for each region in the frame. The numerical value of the moving body detection score in a region with a high possibility that the moving body exists is higher than that in other regions. Note that a method for calculating the moving body detection score is not particularly limited, and other existing techniques can be applied. Next, the detection unit 443 determines whether the moving body detection score is less than the first threshold 432. The detection unit 443 determines that the moving body is imaged in a portion in the frame where the moving body detection score is equal to or more than the threshold. In a case where the first threshold 432 is low, more regions are detected as the region where the moving body exists, as compared with a case where the first threshold 432 is high. That is, if the first setting unit 442 sets the first threshold 432 to be low, the moving body is easily detected from the frame.

FIG. 5 is a diagram illustrating an example of a frame in which a moving body is detected. A frame 10 illustrated in FIG. 5 is a frame included in the video acquired by the acquisition unit 441. In a case where a moving body 20 is imaged in the frame 10 as illustrated in FIG. 5, a moving body detection score near the moving body 20 is calculated to be higher than a moving body detection score in other regions. In a case where the moving body detection score near the moving body 20, that is, in a region 30 is equal to or more than the threshold, the detection unit 443 determines that the moving body is imaged in the region 30.

Returning to FIG. 4, the description will be continued.

The masking unit 444 executes masking processing, that is, blurs the region where the detection unit 443 detects the moving body. A method of the masking processing is not particularly limited and is performed by an existing technique.

In this way, since the moving-body detection device 400 according to the second example embodiment sets the threshold of the moving body detection score to be low, in a case where the dispersion of the frame is small, that is, there is a high possibility that the moving body imaged in the frame is clear, the moving body is easily detected. Since the moving-body detection device 400 sets the threshold of the moving body detection score to be high in a case where the dispersion of the frame is small, that is, there is a high possibility that the moving body imaged in the frame is unclear, the unclear moving body is hardly detected. Therefore, the moving-body detection device 400 can accurately detect a clear moving body, that is, a moving body that needs to be blurred.

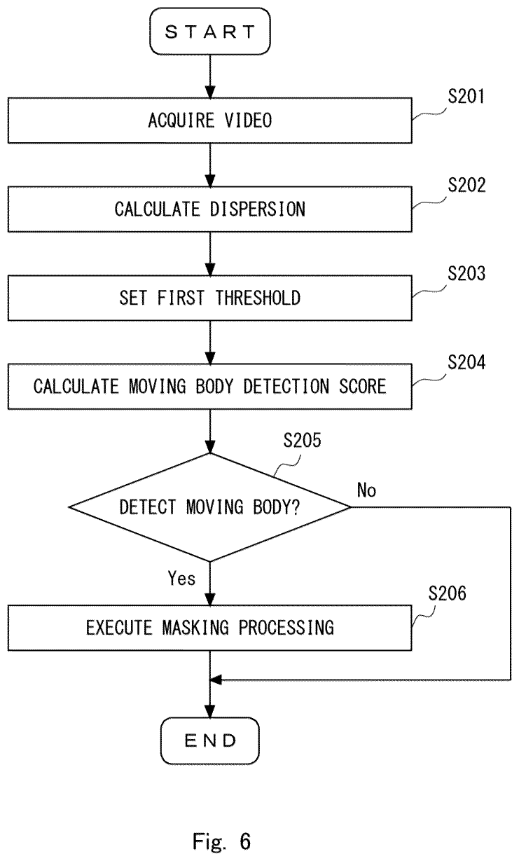

Next, an operation of the moving-body detection device 400 at the time of moving body detection will be described, with reference to FIG. 6. FIG. 6 is a flowchart illustrating a flow of moving-body detection processing.

First, the acquisition unit 441 acquires the video from the imaging apparatus 300 (step S201). Next, the first setting unit 442 calculates dispersion of the frame included in the video acquired in step S201 (step S202). Next, the first setting unit 442 sets the first threshold 432 based on the dispersion calculated in step S202 (step S203) and stores the first threshold 432 in the storage unit 430. Next, the detection unit 443 calculates the moving body detection score for the frame included in the video acquired in step S201 (step S204). Next, the detection unit 443 detects the moving body based on the first threshold 432 stored in the storage unit 430 (step S205).

In a case where the moving body detection score is less than the first threshold 432 in all the regions in the frame, the detection unit 443 determines that the moving body is not detected from the frame (step S205, No), and the detection unit 443 ends the detection of the moving body. In a case where a region in which the moving body detection score is equal to or more than the first threshold 432 exists in the frame, the detection unit 443 determines that the moving body is detected from the frame (step S205, Yes). In a case where determined that the moving body is detected (step S205, Yes), the masking unit 444 executes the masking processing on the region in which the moving body is detected (step S206). In this way, since the moving-body detection device 400 according to the second example embodiment adjusts the first threshold 432 according to the dispersion of the frame and detects the moving body, it is possible to accurately detect the moving body that needs to be masked.

### Third Example Embodiment

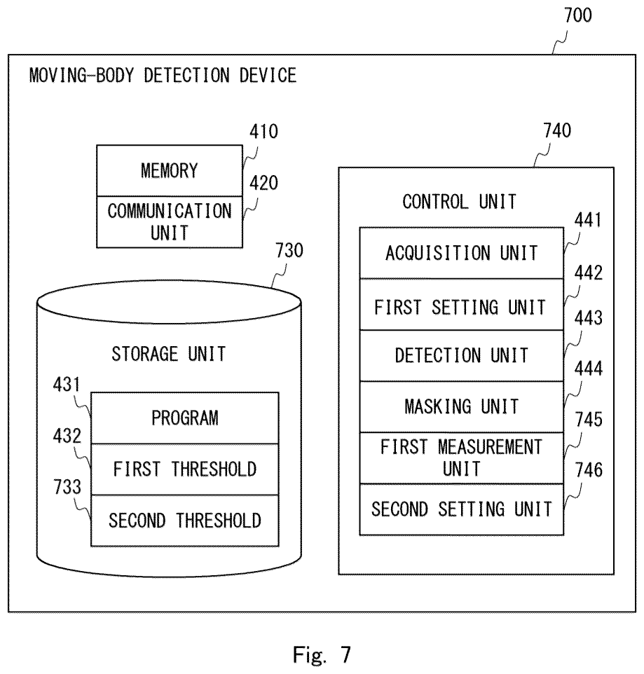

A third example embodiment is a modified example of the second example embodiment described above. In the third example embodiment, necessity of masking is determined based on related information. FIG. 7 is a block diagram illustrating a configuration of a moving-body detection device 700 according to the third example embodiment. The moving-body detection device 700 is different from the moving-body detection device 400 illustrated in FIG. 4 in that a storage unit 730 is included instead of the storage unit 430 and a control unit 740 is included instead of the control unit 440. Since other configurations overlap with those of the first or second example embodiment and the like, the description thereof is omitted as appropriate. The storage unit 730 is a storage apparatus that stores a second threshold 733, in addition to a program 431 and a first threshold 432. The control unit 740 includes a first measurement unit 745 and a second setting unit 746, in addition to an acquisition unit 441, a first setting unit 442, a detection unit 443, and a masking unit 444.

The acquisition unit 441 acquires the video from the imaging apparatus 300 and acquires vehicle information from the recording apparatus 320. The first setting unit 442 sets the moving body detection condition based on the related information. Specifically, first, the first setting unit 442 calculates a dispersion of each frame included in the video acquired by the acquisition unit 441. Next, the first setting unit 442 sets the first threshold 432 based on the dispersion of the frame and stores the first threshold 432 in the storage unit 730. The detection unit 443 detects a moving body from the video acquired by the acquisition unit 441. Specifically, the detection unit 443 calculates a moving body detection score, for each frame included in the video acquired by the acquisition unit 441. Next, the detection unit 443 determines whether the moving body detection score is less than the first threshold 432.

The first measurement unit 745 calculates the number of pixels of an image of the moving body detected by the detection unit 443. The first measurement unit 745 sets, for example, a region 30 illustrated in FIG. 5 as the image in which the moving body is detected and calculates the number of pixels of the region 30. In the third example embodiment, the second setting unit 746 sets the second threshold 733 based on related information and stores the second threshold 733 in the storage unit 730. The second threshold 733 is a threshold used in a case where necessity of masking on the image is determined.

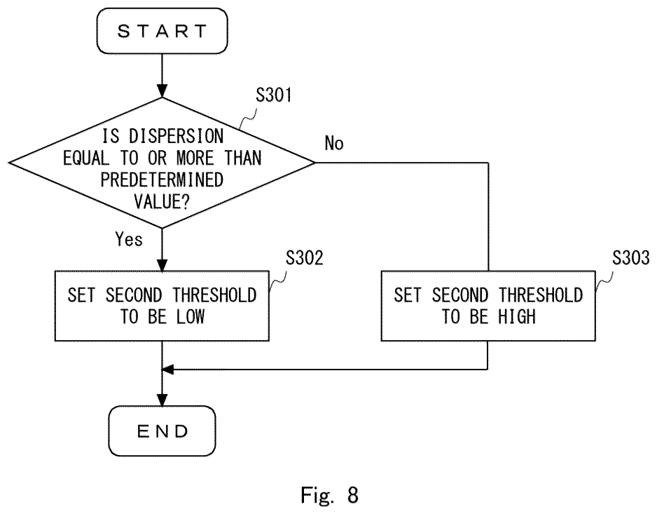

FIG. 8 is a flowchart illustrating a flow of second threshold setting processing according to the third example embodiment. As illustrated in FIG. 8, in the third example embodiment, the second setting unit 746 sets the second threshold 733 based on the related information. Specifically, the second setting unit 746 sets the second threshold 733 based on the dispersion of the frame calculated by the first setting unit 442. Specifically, in a case where the dispersion is equal to or more than a predetermined value (step S301, Yes), the second setting unit 746 sets the second threshold 733 to be lower than that in a case where the dispersion is less than the predetermined value (step S302). In a case where the dispersion is less than the predetermined value (step S301, No), the second setting unit 746 sets the second threshold 733 to be higher than that in a case where the dispersion is equal to or more than the predetermined value (step S303).

Returning to FIG. 7, the description will be continued.

In the third example embodiment, in a case where the number of pixels of the image in which the moving body is detected is equal to or more than the second threshold 733, the masking unit 444 executes the masking processing on the image. In a case where the dispersion of the frame is small, there is a higher possibility that the moving body imaged in the video is blurred, as compared with a case where the dispersion of the frame is large. Since it is not necessary to execute the masking processing in a case where the moving body is blurred, the second setting unit 746 sets the second threshold 733 to be higher in a case where the dispersion of the frame is small. As a result, the masking unit 444 can extract only the image on which it is necessary to execute the masking processing and can execute the masking processing on the image.

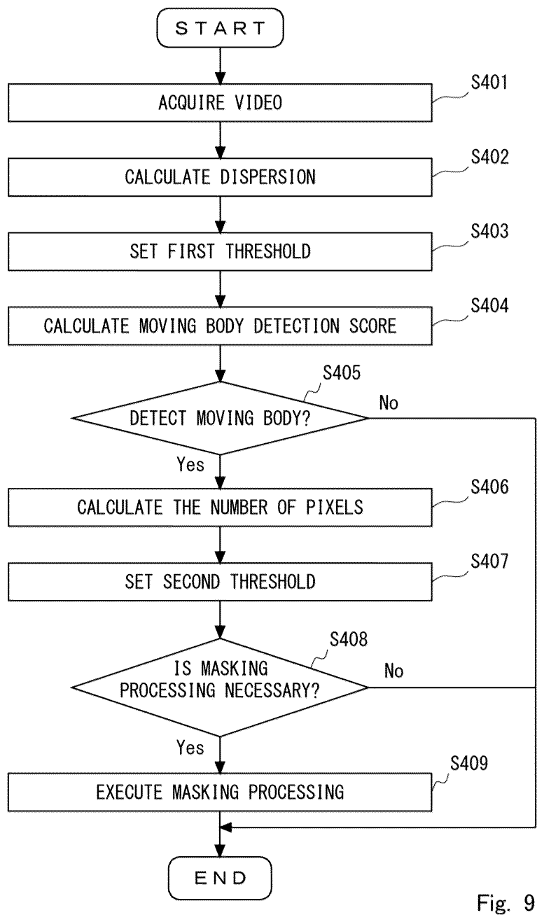

Next, an operation of the moving-body detection device 700 at the time of moving body detection will be described with reference to FIG. 9. FIG. 9 is a flowchart illustrating a flow of moving-body detection processing.

First, the acquisition unit 441 acquires the video from the imaging apparatus 300 (step S401). Next, the first setting unit 442 calculates the dispersion of the frame included in the video acquired in step S401 (step S402). Next, the first setting unit 442 sets the first threshold 432 based on the dispersion calculated in step S402 (step S403) and stores the first threshold 432 in the storage unit 730. Next, the detection unit 443 calculates the moving body detection score for the frame included in the video acquired in step S401 (step S404). Next, the detection unit 443 detects the moving body based on the first threshold 432 stored in the storage unit 730 (step S405).

In a case where the moving body detection score is less than the first threshold 432 in all the regions in the frame, the detection unit 443 determines that the moving body is not detected from the frame (step S405, No), and the detection unit 443 ends the detection of the moving body. In a case where a region in which the moving body detection score is equal to or more than the first threshold 432 exists in the frame, the detection unit 443 determines that the moving body is detected from the frame (step S405, Yes).

In a case where determined that the moving body is detected (step S405, Yes), the first measurement unit 745 calculates the number of pixels of the image in which the moving body is detected (step S406). Next, the second setting unit 746 sets the second threshold 733 based on the dispersion of the frame calculated in step S402 (step S407) and stores the second threshold 733 in the storage unit 730. Next, the masking unit 444 determines whether the masking processing on the image detected in step S405 is necessary (step S408). In a case where the number of pixels calculated in step S406 is less than the second threshold 733, the masking unit 444 determines that the masking processing on the image is not necessary (step S408, No), and ends the masking processing. In a case where the number of pixels calculated in step S406 is equal to or more than the second threshold 733, the masking unit 444 determines that the masking processing on the image is necessary (step S408, Yes), and executes the masking processing (step S409).

In this way, since the moving-body detection device 700 according to the third example embodiment sets the second threshold 733 based on the related information and determines the necessity of the masking processing, the image on which it is necessary to execute the masking processing can be accurately detected.

### Fourth Example Embodiment

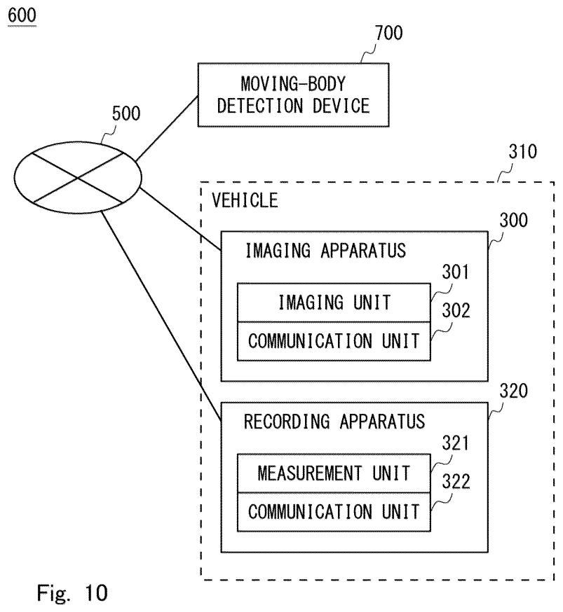

A fourth example embodiment is a modified example of the second and third example embodiments described above. In the third example embodiment, a case where the second threshold 733 is set based on the related information has been described. On the other hand, in the fourth example embodiment, the second threshold 733 is set based on vehicle information. FIG. 10 is a block diagram illustrating a configuration of a moving-body detection system 600 according to the fourth example embodiment. The moving-body detection system 600 further includes a recording apparatus 320, as compared with the moving-body detection system 200 illustrated in FIG. 3. The moving-body detection system 600 is different from the moving-body detection system 200 in that a moving-body detection device 700 is included instead of the moving-body detection device 400. Each of an imaging apparatus 300 and the recording apparatus 320 is connected to the moving-body detection device 700 via a network 500. Since other configurations are similar to the configurations described in the second or third example embodiment, description thereof is appropriately omitted.

The recording apparatus 320 is an apparatus that records the vehicle information such as a traveling speed of a vehicle 310. The recording apparatus 320 is provided in the vehicle 310. The recording apparatus 320 includes a measurement unit 321 and a communication unit 322. The measurement unit 321 measures the vehicle information including information regarding the vehicle 310. The vehicle information is information recorded in the vehicle 310 and is, for example, the traveling speed of the vehicle 310. The communication unit 322 is a communication interface with the network 500. The communication unit 322 transmits the vehicle information measured by the measurement unit 321 to the moving-body detection device 700 via the network 500.

In the fourth example embodiment, an acquisition unit 441 acquires a video from the imaging apparatus 300 and acquires the vehicle information from the recording apparatus 320. The second setting unit 746 sets the second threshold 733 based on the vehicle information and stores the second threshold 733 in a storage unit 730.

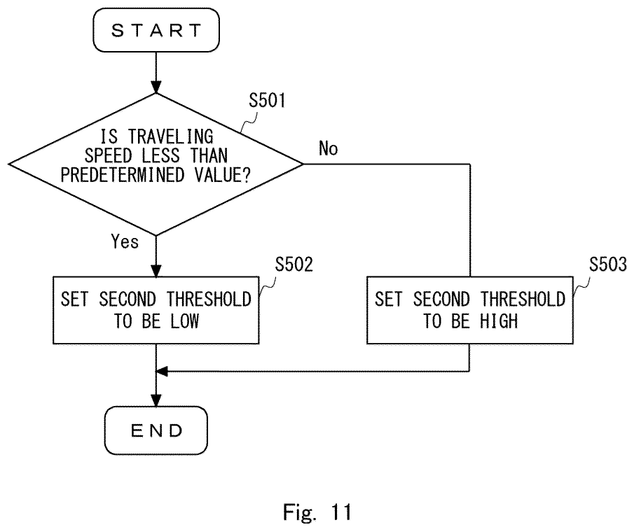

FIG. 11 is a flowchart illustrating a flow of second threshold setting processing according to the fourth example embodiment. In the fourth example embodiment, the second setting unit 746 sets the second threshold 733 based on the traveling speed of the vehicle 310 at the time during a video is imaged. In a case where the traveling speed is less than a predetermined value (step S501, Yes), the second setting unit 746 sets the second threshold 733 to be lower than that in a case where the traveling speed is equal to or more than the predetermined value (step S502). In a case where the traveling speed is equal to or more than the predetermined value (step S501, No), the second setting unit 746 sets the second threshold 733 to be higher than that in a case where the traveling speed is less than the predetermined value (step S503).

In the fourth example embodiment, in a case where the number of pixels of the image in which the moving body is detected is equal to or more than the second threshold 733, the masking unit 444 executes the masking processing on the image. In a case where the traveling speed of the vehicle 310 is high, there is a higher possibility that the moving body imaged in the video is blurred, as compared with a case where the traveling speed is low. Since it is not necessary to execute the masking processing in a case where the moving body is blurred, the second setting unit 746 sets the second threshold 733 to be higher in a case where the traveling speed is high. As a result, the masking unit 444 can extract only the image on which it is necessary to execute the masking processing and can execute the masking processing on the image.

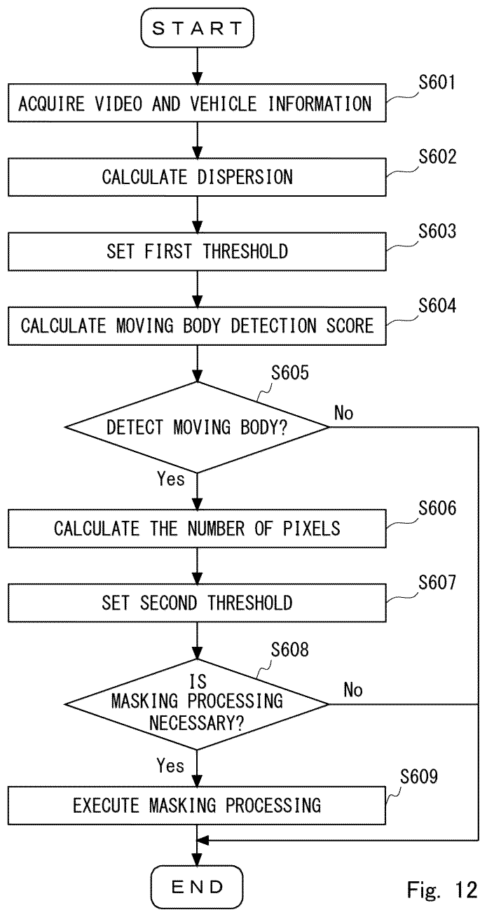

Next, an operation of the moving-body detection device 700 according to the fourth example embodiment will be described, with reference to FIG. 12. FIG. 12 is a flowchart illustrating a flow of moving-body detection processing according to the fourth example embodiment.

First, the acquisition unit 441 acquires the video from the imaging apparatus 300 and acquires the vehicle information from the recording apparatus 320 (step S601). Next, a first setting unit 442 sets dispersion of a frame included in the video acquired in step S601 (step S602). Next, the first setting unit 442 sets a first threshold 432 based on the dispersion calculated in step S602 (step S603) and stores the first threshold 432 in the storage unit 730. Next, a detection unit 443 calculates a moving body detection score for the frame included in the video acquired in step S601 (step S604). Next, the detection unit 443 detects the moving body based on the first threshold 432 stored in the storage unit 730 (step S605).

In a case where the moving body detection score is less than the first threshold 432 in all the regions in the frame, the detection unit 443 determines that the moving body is not detected from the frame (step S605, No), and the detection unit 443 ends the detection of the moving body. In a case where a region in which the moving body detection score is equal to or more than the first threshold 432 exists in the frame, the detection unit 443 determines that the moving body is detected from the frame (step S605, Yes).

In a case where determined that the moving body is detected (step S605, Yes), the first measurement unit 745 calculates the number of pixels of the image in which the moving body is detected (step S606). Next, the second setting unit 746 sets the second threshold 733 based on the vehicle information acquired in step S601 (step S607) and stores the second threshold 733 in the storage unit 730. Next, the masking unit 444 determines whether the masking processing on the image detected in step S605 is necessary (step S608). In a case where the number of pixels calculated in step S606 is less than the second threshold 733, the masking unit 444 determines that the masking processing on the image is not necessary (step S608, No), and ends the masking processing. In a case where the number of pixels calculated in step S606 is equal to or more than the second threshold 733, the masking unit 444 determines that the masking processing on the image is necessary (step S608, Yes), and executes the masking processing (step S609).

In a moving-body detection method according to the fourth example embodiment, since the second threshold 733 is set based on the vehicle information and it is determined whether the masking processing is necessary, it is possible to accurately detect the image on which it is necessary to execute the masking processing.

### Fifth Example Embodiment

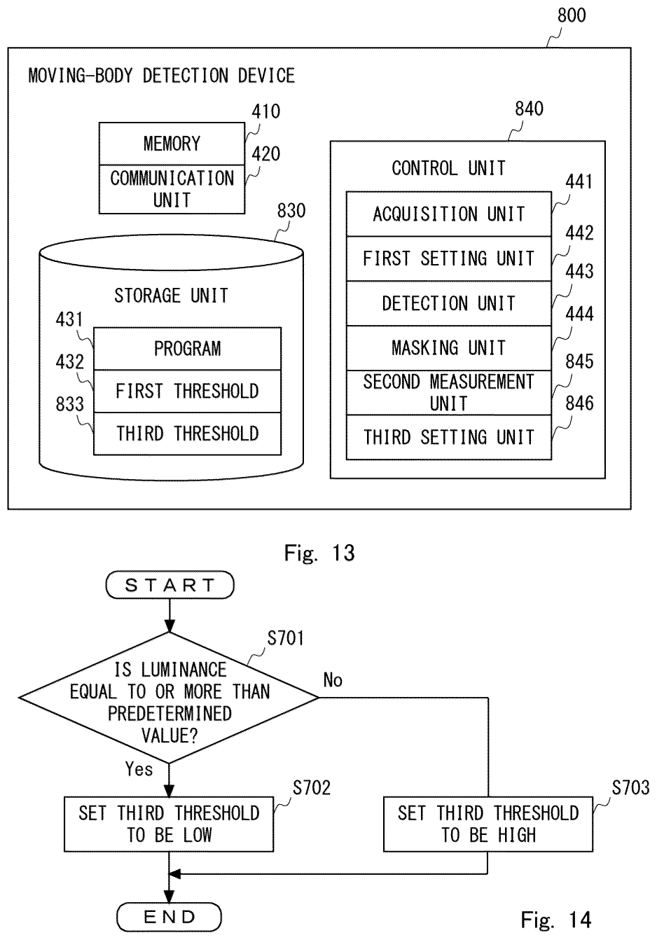

A fifth example embodiment is a modified example of the third example embodiment described above. In the third example embodiment, a case has been described where the necessity of the masking is determined based on the dispersion of the frame. On the other hand, in the fifth example embodiment, the necessity of masking is determined based on brightness of the frame. FIG. 13 is a block diagram illustrating a configuration of a moving-body detection device 800 according to the fifth example embodiment. The moving-body detection device 800 is different from the moving-body detection device 400 illustrated in FIG. 4 in that a storage unit 830 is included instead of the storage unit 430 and a control unit 840 is included instead of the control unit 440. Since other configurations overlap with those of the first or second example embodiment or the like, the description thereof is omitted as appropriate. The storage unit 830 is a storage apparatus that stores a third threshold 833, in addition to a program 431 and a first threshold 432. The control unit 740 includes a second measurement unit 845 and a third setting unit 846, in addition to an acquisition unit 441, a first setting unit 442, a detection unit 443, and a masking unit 444.

The second measurement unit 845 calculates a luminance of a frame included in a video acquired by the acquisition unit 441. The luminance of the frame is a numerical value indicating brightness in the frame and is calculated by an existing technique. The third setting unit 846 sets the third threshold 833 based on the luminance of the frame and stores the luminance in the storage unit 730. The third threshold 833 is a threshold used in a case where necessity of masking on an image is determined.

FIG. 14 is a flowchart illustrating a flow of second threshold setting processing according to the fifth example embodiment. In the fifth example embodiment, the third setting unit 846 sets the third threshold 833 based on the luminance of the frame calculated by the second measurement unit 845. Specifically, in a case where the luminance of the frame is equal to or more than a predetermined value (step S701, Yes), the third setting unit 846 sets the third threshold 833 to be lower than that in a case where the luminance of the frame is less than the predetermined value (step S702). In a case where the luminance of the frame is less than the predetermined value (step S701, No), the third setting unit 846 sets the third threshold 833 to be higher than that in a case where the luminance of the frame is equal to or more than the predetermined value (step S703).

Returning to FIG. 13, the description will be continued.

In the fifth example embodiment, in a case where the number of pixels of an image in which a moving body is detected is equal to or more than the third threshold 833, the masking unit 444 executes masking processing on the image. In a case where the frame is dark, there is a higher possibility that the moving body imaged in the video is blurred, as compared with a case where the frame is bright. Since it is not necessary to execute the masking processing in a case where the moving body is blurred, the second setting unit 746 sets the second threshold 733 to be lower in a case where the frame is bright, that is, the luminance of the frame is equal to or more than the predetermined value. As a result, the masking unit 444 can extract only the image on which it is necessary to execute the masking processing and can execute the masking processing on the image.

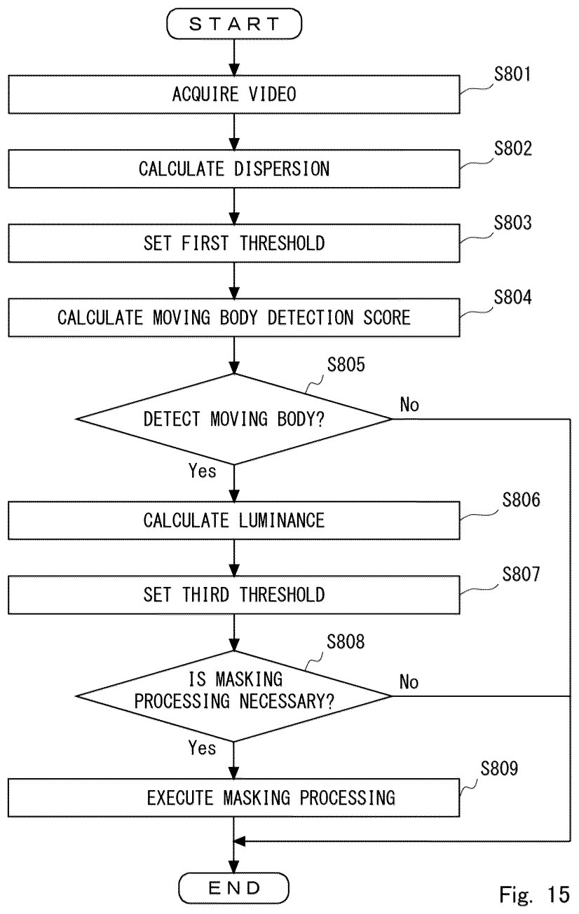

Next, an operation of the moving-body detection device 800 at the time of moving body detection will be described, with reference to FIG. 15. FIG. 15 is a flowchart illustrating a flowchart of a flow of moving-body detection processing according to the fifth example embodiment.

First, the acquisition unit 441 acquires a video from an imaging apparatus 300 (step S801). Next, the first setting unit 442 sets dispersion of a frame included in the video acquired in step S801 (step S802). Next, the first setting unit 442 sets the first threshold 432 based on the dispersion calculated in step S802 (step S803) and stores the first threshold 432 in the storage unit 730. Next, the detection unit 443 calculates a moving body detection score for the frame included in the video acquired in step S801 (step S804). Next, the detection unit 443 detects a moving body based on the first threshold 432 stored in the storage unit 730 (step S805).

In a case where the moving body detection score is less than the first threshold 432 in all regions in the frame, the detection unit 443 determines that the moving body is not detected from the frame (step S805, No), and the detection unit 443 ends the detection of the moving body. In a case where a region in which the moving body detection score is equal to or more than the first threshold 432 exists in the frame, the detection unit 443 determines that the moving body is detected from the frame (step S805, Yes).

In a case where determined that the moving body is detected (step S805, Yes), the second measurement unit 845 calculates the luminance of the frame in which the moving body is detected (step S806). Next, the third setting unit 846 sets the third threshold 833 based on the luminance of the frame calculated in step S806 (step S807) and stores the third threshold 833 in the storage unit 730. Next, the masking unit 444 determines whether the masking processing on the image detected in step S805 is necessary (step S808). In a case where the number of pixels calculated in step S806 is less than the third threshold 833, the masking unit 444 determines that the masking processing on the image is not necessary (step S808, No), and ends the masking processing. In a case where the number of pixels calculated in step S806 is equal to or more than the third threshold 833, the masking unit 444 determines that the masking processing on the image is necessary (step S808, Yes), and executes the masking processing (step S809).

In this way, since the moving-body detection device 800 according to the fifth example embodiment sets the third threshold 833 based on the luminance of the frame and determines whether the masking processing is necessary, it is possible to accurately detect the image on which it is necessary to execute the masking processing. In the fifth example embodiment described above, although the brightness of the frame is calculated by calculating the luminance of the frame, the brightness of the frame may be calculated by another method. For example, the brightness of the frame may be calculated based on a luminosity of the frame or may be calculated based on a time during the frame is imaged.

In a case where the brightness of the frame is calculated based on the luminosity of the frame, the second measurement unit 845 calculates the luminosity of the frame included in the video acquired by the acquisition unit 441. The luminosity of the frame is a numerical value indicating the brightness of the frame and is calculated by an existing technique. In this case, the third setting unit 846 sets the third threshold 833 based on the luminosity of the frame and stores the third threshold 833 in the storage unit 730. In a case where the luminosity of the frame is equal to or more than a predetermined value, the third setting unit 846 sets the third threshold 833 to be lower than that in a case where the luminosity of the frame is less than the predetermined value. In a case where the luminosity of the frame is less than the predetermined value, the third setting unit 846 sets the third threshold 833 to be higher than that in a case where the luminosity of the frame is equal to or more than the predetermined value.

In a case where the brightness of the frame is calculated based on the time during the frame is imaged, the third setting unit 846 sets the third threshold 833 based on the time during the frame is imaged and stores the third threshold 833 in the storage unit 730. Specifically, for example, in a case where the frame is imaged between 6:00 am and 5:00 pm, that is, the frame is imaged in the daytime, the third setting unit 846 sets the third threshold 833 to be lower than that in a case where the frame is imaged in the nighttime. In a case where the frame is imaged between 5:00 pm and 6:00 am, that is, the frame is imaged in the nighttime, the third setting unit 846 sets the third threshold 833 to be higher than that in a case where the frame is imaged in the daytime.

In the above-described example embodiments, the configuration of the hardware has been described, but the present disclosure is not limited thereto. According to the present disclosure, any processing can also be achieved by causing a CPU to execute a computer program.

In the above-described example, the program can be stored using various types of non-transitory computer readable medium and supplied to a computer. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and a semiconductor memory (for example, a mask ROM, a programmable ROM (PROM), an erasable PROM (EPROM), a flash ROM, or a random access memory (RAM)). The program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

The present disclosure is not limited to the above example embodiments, and can be appropriately changed without departing from the scope. The present disclosure may be implemented by appropriately combining the example embodiments.

Some or all of the above example embodiments may be described as the following Supplementary Notes, but are not limited to the following.
(Supplementary Note A1)

A moving-body detection device including:
an acquisition unit for acquiring an imaged video;
a first setting unit for setting a moving body detection condition based on related information including information related to the video; and
a detection unit for detecting a moving body from a frame included in the video based on the moving body detection condition.
(Supplementary Note A2)

The moving-body detection device according to supplementary note A1, in which
the acquisition unit further acquires vehicle information including information recorded in the vehicle, and
the first setting unit sets the moving body detection condition based on the related information and the vehicle information.
(Supplementary Note A3)

The moving-body detection device according to supplementary note A1, in which
the first setting unit calculates a dispersion of the frame and sets a first threshold indicating a threshold of a moving body detection score used to determine that a moving body is imaged, based on the dispersion, and
the detection unit calculates a moving body detection score in the frame and detects a moving body from the frame based on the first threshold.
(Supplementary Note A4)

The moving-body detection device according to supplementary note A1, further including:
a first measurement unit for calculating the number of pixels of an image of the detected moving body;
a second setting unit for setting a second threshold indicating a threshold of the number of pixels used to determine necessity of masking processing on the image; and
a masking unit for executing the masking processing on the image in a case where the number of pixels is equal to or more than the second threshold.
(Supplementary Note A5)

The moving-body detection device according to supplementary note A4, in which
the first setting unit calculates a dispersion of the frame and sets a first threshold indicating a threshold of a moving body detection score used to determine that a moving body is imaged based on the dispersion, and
the second setting unit sets a second threshold based on the dispersion and the number of pixels.
(Supplementary Note A6)

The moving-body detection device according to supplementary note A4, in which
the acquisition unit further acquires vehicle information including information recorded in a vehicle in which the video is imaged, and
the second setting unit sets the second threshold based on at least one of the related information and the vehicle information.
(Supplementary Note A7)

The moving-body detection device according to supplementary note A1, further including:
a second measurement unit for calculating brightness of an image of the detected moving body;
a third setting unit for setting a third threshold indicating a threshold of the brightness used to determine necessity of masking processing on the image based on the related information; and
a masking unit for executing the masking processing on the image in a case where the brightness is equal to or more than the third threshold.
(Supplementary Note B1)

A moving-body detection system including:
an imaging apparatus configured to be provided in a vehicle and image a video around the vehicle; and
a moving-body detection device communicable with the imaging apparatus,
in which the moving-body detection device acquires the video imaged by the imaging apparatus, sets a moving body detection condition based on related information including information related to the video, and detects a moving body from a frame included in the video based on the moving body detection condition.
(Supplementary Note B2)

The moving-body detection system according to supplementary note B1, in which the moving-body detection device calculates the dispersion of the frame and sets a first threshold indicating a threshold of a moving body detection score used to determine that a moving body is imaged based on the dispersion, and calculates a moving body detection score in the frame and detects a moving body from the frame based on the first threshold.
(Supplementary Note C1)

A moving-body detection method performed by a computer, including:
acquiring an imaged video;
setting a moving body detection condition based on related information including information related to the video; and
detecting a moving body from a frame included in the video based on the moving body detection condition.
(Supplementary Note D1)

A non-transitory computer readable medium storing a moving-body detection program for causing a computer to execute processing including:
processing for acquiring an imaged video;
processing for setting a moving body detection condition based on related information including information related to the video; and
processing for detecting a moving body from a frame included in the video based on the moving body detection condition.

While the present invention has been particularly shown and described with reference to example embodiments (and examples) thereof, the present invention is not limited to these example embodiments (and examples). It will be understood by those of ordinary skill in the art that various changes in form and details may be made therein without departing from the spirit and scope of the present invention as defined by the claims.

### REFERENCE SIGNS LIST

10 frame
20 moving body
30 region
100 moving-body detection device
110 acquisition unit
120 first setting unit
130 detection unit
200 moving-body detection system
300 imaging apparatus
301 imaging unit
302 communication unit
310 vehicle
320 recording apparatus
321 measurement unit
322 communication unit
400 moving-body detection device
410 memory
420 communication unit
430 storage unit
431 program
432 first threshold
440 control unit
441 acquisition unit
442 first setting unit
443 detection unit
444 masking unit
500 network
600 moving-body detection system
700 moving-body detection device
730 storage unit
733 second threshold
740 control unit
745 first measurement unit
746 second setting unit
800 moving-body detection device
830 storage unit
833 third threshold
840 control unit
845 second measurement unit
846 third setting unit

What is claimed is:

1. A moving-body detection device comprising:
at least one memory storing instructions, and
at least one processor configured to execute the instructions to;
acquire an imaged video;
set a moving body detection condition based on related information including information related to the video; and
detect a moving body from a frame included in the video based on the moving body detection condition.

2. The moving-body detection device according to claim 1, wherein the at least one processor is further configured to execute the instructions to;
calculate a dispersion of the frame and sets a first threshold indicating a threshold of a moving body detection score used to determine that a moving body is imaged, based on the dispersion, and
calculate a moving body detection score in the frame and detects a moving body from the frame based on the first threshold.

3. The moving-body detection device according to claim 1, wherein the at least one processor is further configured to execute the instructions to;
calculate the number of pixels of an image of the detected moving body;
set a second threshold indicating a threshold of the number of pixels used to determine necessity of masking processing on the image; and
execute the masking processing on the image in a case where the number of pixels is equal to or more than the second threshold.

4. The moving-body detection device according to claim 3, wherein the at least one processor is further configured to execute the instructions to;
calculate the dispersion of the frame and sets a first threshold indicating a threshold of a moving body detection score used to determine that a moving body is imaged based on the dispersion, and
set a second threshold based on the dispersion and the number of pixels.

5. The moving-body detection device according to claim 3, wherein the at least one processor is further configured to execute the instructions to;
acquire vehicle information including information recorded in a vehicle in which the video is imaged, and
set the second threshold based on at least one of the related information and the vehicle information.

6. The moving-body detection device according to claim 1, wherein the at least one processor is further configured to execute the instructions to;
calculate brightness of an image of the detected moving body;
set a third threshold indicating a threshold of the brightness used to determine necessity of masking processing on the image based on the related information; and
execute the masking processing on the image in a case where the brightness is equal to or more than the third threshold.

7-8. (canceled)

9. A moving-body detection method performed by a computer, comprising:
acquiring an imaged video;
setting a moving body detection condition based on related information including information related to the video; and
detecting a moving body from a frame included in the video based on the moving body detection condition.

10. A non-transitory computer readable medium storing a moving-body detection program for causing a computer to execute processing comprising:
processing for acquiring an imaged video;
processing for setting a moving body detection condition based on related information including information related to the video; and
processing for detecting a moving body from a frame included in the video based on the moving body detection condition.
